(19) United States
(12) Patent Application Publication
(10) Pub. No.: US 2023/0195836 A1
(43) Pub. Date: Jun. 22, 2023

(54) ONE-DIMENSIONAL COMPUTATIONAL UNIT FOR AN INTEGRATED CIRCUIT

(71) Applicant: Google LLC, (US)

(72) Inventors: Reiner Pope, Sunnyvale, CA (US); Charles Ross, Mountain View, CA (US); Michial Allen Gunter, San Francisco, CA (US); Wren Romano, Mountain View, CA (US)

(21) Appl. No.: 18/083,333

(22) Filed: Dec. 16, 2022

Related U.S. Application Data
(60) Provisional application No. 63/265,491, filed on Dec. 16, 2021.

(51) Int. Cl. G06F 17/16; G06N 3/044; G06N 3/048

(52) U.S. Cl. CPC G06F 17/16; G06N 3/044; G06N 3/048

(57) ABSTRACT

Methods, systems, and apparatus, including computer-readable media, are described for implementing a one-dimensional computational unit in an integrated circuit for a machine-learning (ML) hardware accelerator.

### BACKGROUND

This specification generally relates to integrated circuits used to perform machine-learning computations.

Neural networks are machine-learning models that employ one or more layers of nodes to generate an output, e.g., a classification, for a received input. Some neural networks include one or more hidden layers in addition to an output layer. Some neural networks can be convolutional neural networks (CNNs) configured for image processing or recurrent neural networks (RNNs) configured for speech and language processing. Different types of neural network architectures can be used to perform a variety of tasks related to classification or pattern recognition, predictions that involve data modeling, and information clustering.

A neural network layer can have a corresponding set of parameters or weights. The weights are used to process inputs (e.g., a batch of inputs) through the neural network layer to generate a corresponding output of the layer for computing a neural network inference. A batch of inputs and set of kernels can be represented as a tensor, i.e., a multi-dimensional array, of inputs and weights. A hardware accelerator is a special-purpose integrated circuit for implementing neural networks. The circuit includes memory with locations corresponding to elements of a tensor that may be traversed or accessed using control logic of the circuit.

### SUMMARY

This specification describes techniques for an improved circuit architecture for implementing an application-specific integrated hardware circuit. The circuit architecture includes an array of super tiles, an array of super one-dimensional compute units, and a routing network. Each super tile can include multiple individual compute tiles. The individual compute tiles of a super tile can be used to execute, either sequentially or concurrently, different portions of a larger computation for a machine-learning workload. Similarly, each super one-dimensional compute unit can include multiple individual one-dimensional compute units.

The individual one-dimensional compute units can be configured as vector processors or vector computation units that operate on vectors of values received from, for example, a super tile or at least one individual compute tile. The circuit architecture may be used in special-purpose processor that implements a multi-layer neural network model and the one-dimensional compute units can perform various types of arithmetic operations for a given neural network task. For example, the one-dimensional compute unit can perform dot product accumulations on partial sum values computed at a super tile for a layer of the neural network and apply activation functions to vectors of accumulated values.

The routing network is dynamically configurable and includes multiple data paths. The data paths can be controllable bus lines that provide interconnections between the array of super tiles and the array of super one-dimensional compute units. For example, the routing network provides interconnections between: i) a super tile and a super one-dimensional compute unit; ii) an individual compute tile and an individual one-dimensional compute unit; iii) two or more super tiles; iv) two or more super one-dimensional compute units; or v) various combinations of these. The routing network also provides interconnections between individual compute tiles of a super tile and between individual one-dimensional compute units of a super one-dimensional compute unit.

In general, in some aspects, the subject matter of the present application can be embodied in an integrated circuit for implementing a neural network comprising a plurality of neural network layers, in which the circuit includes: multiple compute tiles configured to process data used to generate an output of a neural network layer; a first vector unit configured to perform operations on first data values provided along a first dimension of the integrated circuit from a first subset of the plurality of compute tiles; a second vector unit configured to perform operations on second data values provided along the first dimension of the integrated circuit from a second subset of the multiple compute tiles; a set of data paths configured to couple a given vector unit and a particular subset of compute tiles such that data values are routable between the given vector unit and the particular subset of compute tiles; and a set of vector data paths configured to couple the first vector unit and the second vector unit to support neural network computations that are performed using one or more of the plurality of compute tiles.

Implementations of the integrated circuit can include one or more of the following features. For example, in some implementations, the multiple compute tiles and the first and second vector units cooperate to generate respective outputs for each layer of the plurality of neural network layers based on data values that are routed using the set of data paths and the set of vector data paths.

In some implementations, the circuit includes: a first set of data paths configured to couple the first vector unit and the first subset of compute tiles such that the first data values are routable between the first vector unit and the first subset of compute tiles; and a second set of data paths configured to couple the second vector unit and the second subset of compute tiles such that the second data values are routable between the second vector unit and the second subset of compute tiles.

In some implementations, the circuit includes: a first set of vector data paths configured to couple the first vector unit and the second vector unit along the first dimension of the integrated circuit to support the neural network computations that are performed using one or more of the plurality of compute tiles.

In some implementations, the circuit includes: a second set of vector data paths configured to couple the first vector unit or the second vector unit to another vector unit along a second dimension of the integrated circuit to support the neural network computations that are performed using one or more of the multiple compute tiles.

In some implementations, the integrated circuit is a neural network processor configured to perform deterministic operations based on multiple predetermined instructions that are executed using one or more sets of clock signals; and the first and second set of data paths and the first and second set of vector data paths are a dynamically configurable routing network of the neural network processor that dynamically routes data processed by the neural network processor.

In some implementations, data paths in the first set of data paths are partial-sum buses configured to provide a first portion of partial sums from the first subset of compute tiles to the first vector unit when performing the neural network computations and data paths in the second set of data paths are partial-sum buses configured to provide a second portion of partial sums from the second subset of compute tiles to the second vector unit when performing the neural network computations.

In some implementations, the data include: a first multiple of inputs that are processed at the neural network layer to generate a first multiple of activation values representing the output of the neural network layer; or a second multiple of inputs that are processed at a second neural network layer to generate a second multiple of activation values representing an output of the second neural network layer.

In some implementations, the output of the neural network layer is provided as an input to the second neural network layer, such that the first plurality of activation values and the second multiple of inputs are the same.

In some implementations, the circuit further includes: a functional memory unit configured to perform arithmetic operations that enable interpolation of data values obtained from a loadable table of values, in which the loadable table is accessible at the integrated circuit.

In some implementations, each of the multiple of compute tiles includes a respective multi-dimensional array of compute cells that are configured to compute one or more partial sums.

In general, in some aspects, the subject matter of the present disclosure can be embodied in one or more methods for generating an output of a neural network layer using multiple compute tiles of an integrated circuit that implements a neural network comprising multiple neural network layers, the methods including: computing, using the multiple compute tiles, multiple data values from an input dataset; processing, by a first vector unit of the integrated circuit, first data values provided along a first dimension of the integrated circuit from a first subset of the multiple compute tiles; processing, by a second vector unit of the integrated circuit, second data values provided along the first dimension of the integrated circuit from a second subset of the multiple compute tiles; using vector data paths that couple the first and second vector units to route different types of data values between the first vector unit and second vector unit when the first or second data values are being processed; and generating the output of the neural network layer based on the processing of the first or second data values and the different types of data values that are routed between the first and second vector units via the set of vector data paths.

Implementations of the one or more methods can include one or more of the following features. For example, in some implementations, processing the first data values includes: processing the first data values in response to receiving the first data values along the first dimension from the first subset of compute tiles via a first set of data paths that are configured to couple the first subset of compute tiles and the first vector unit, such that the first data values are routable between the first subset of compute tiles and the first vector unit.

In some implementations, processing the second data values comprises: processing the second data values in response to receiving the second data values along the first dimension from the first subset of compute tiles via a second set of data paths that are configured to couple the second subset of compute tiles and the second vector unit, such that the second data values are routable between the second subset of compute tiles and the second vector unit.

In some implementations, data paths in the first set of data paths are partial-sum buses and the one or more methods include: providing, via the first set of data paths, a first portion of partial sums from the first subset of compute tiles to the first vector unit when performing neural network computations at the integrated circuit.

In some implementations, data paths in the second set of data paths are partial-sum buses and the one or more methods include: providing, via the second set of data paths, a second portion of partial sums from the second subset of compute tiles to the second vector unit when performing the neural network computations at the integrated circuit.

In some implementations, the multiple compute tiles and the first and second vector units cooperate to generate respective outputs for each layer of the multiple neural network layers based on data values that are routed using the first and second set of data paths and the vector data paths.

In some implementations, the integrated circuit is a neural network processor configured to perform deterministic operations based on multiple predetermined instructions that are executed using one or more sets of clock signals; and the one or more methods further include: dynamically configuring a routing network of the neural network processor to dynamically route data processed by the neural network processor when performing the neural network computations.

In some implementations, the routing network includes the first and second set of data paths and the vector data paths; and the vector data paths include: a first set of vector data paths configured to couple the first vector unit and the second vector unit along the first dimension of the integrated circuit; and a second set of vector data paths configured to couple the first vector unit or the second vector unit to another vector unit along a second dimension of the integrated circuit.

In general, in some aspects, the subject matter of the present disclosure can be embodied in a system that includes: a processing device; an integrated circuit that implements a neural network including multiple neural network layers; and a non-transitory machine-readable storage device storing instructions for generating an output of a neural network layer using multiple compute tiles of the integrated circuit, the instructions being executable by the processing device to cause performance of operations comprising: computing, using the multiple compute tiles, multiple data values from an input dataset; processing, by a first vector unit of the integrated circuit, first data values provided along a first dimension of the integrated circuit from a first subset of the multiple compute tiles; processing, by a second vector unit of the integrated circuit, second data values provided along the first dimension of the integrated circuit from a second subset of the multiple compute tiles; using vector data paths that couple the first and second vector units to route different types of data values between the first vector unit and second vector unit when the first or second data values are being processed; and generating the output of the neural network layer based on the processing of the first or second data values and the different types of data values that are routed between the first and second vector units via the set of vector data paths.

Other implementations of this and other aspects include corresponding systems, apparatus, and computer programs, configured to perform the actions of the one or more methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by a data processing apparatus, cause the apparatus to perform the actions.

The subject matter described in this specification can be implemented in particular embodiments so as to realize one or more of the following advantages. Relative to prior circuit designs for performing machine-learning applications, the disclosed circuit architecture and data processing techniques provide different combinations of approaches for optimizing how computations are parallelized and/or expanded across compute tiles and one-dimensional compute units. The described circuit architecture and techniques can be integrated in one or more special-purpose processors to enhance the speed and efficiency with which the processors perform tasks and execute computations for various types of machine-learning models.

The described techniques can be used to implement dedicated, hardwired data accumulation pipelines that offer improvements in both cost and power relative to certain general-purpose processors. For example, the techniques can be used to implement a special-purpose hardware neural network processor with dedicated and controllable (e.g., configurable) bus lines that provide data paths for routing data between individual compute or vector units of different resource arrays in an integrated circuit. This allows for a more efficient processing device, particularly in terms of manufacturing cost and power consumption.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example integrated circuit that includes multiple one-dimensional computational units.

FIG. 2 is a block diagram showing an example of a dynamically configuring a routing network of the integrated circuit of FIG. 1.

FIG. 3 illustrates an example internal hardware layout of a one-dimensional computational unit.

FIG. 4 illustrates an example internal hardware layout of an arithmetic unit and a functional memory block of the one-dimensional computational unit of FIG. 3.

FIG. 5 is a flow diagram of an example process for generating an output of a neural network layer using an application-specific integrated circuit.

FIG. 6 illustrates examples of an input tensor and a weight tensor that can be processed using an integrated circuit to generate an example output tensor.

Like reference numbers and designations in the various drawings indicate like elements.

### DETAILED DESCRIPTION

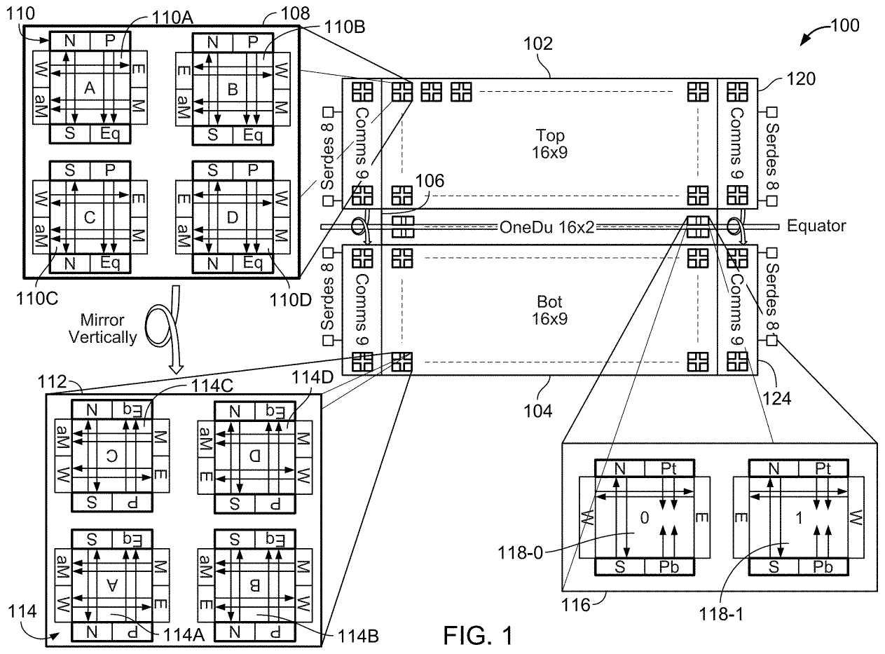

FIG. 1 is a block diagram of an example integrated circuit 100 that includes a circuit architecture for an application-specific integrated circuit (ASIC) that provides computing advantages and improved flexibility relative to other application-specific circuits. In the example of FIG. 1, the architecture of circuit 100 includes an array of super tiles 102, 104, an array of super one-dimensional compute units 106, and one or more communication blocks 120, 124.

Array 102 includes multiple super tiles 108, whereas array 104 includes multiple super tiles 112. The array of super one-dimensional units 106 includes multiple super one-dimensional computational units 116 and can include at least two rows of individual one-dimensional units 118. In some implementations, an example integrated circuit 100 includes a large grid of multi-dimensional grid or array of compute tiles 102, 104 and the array of super one-dimensional units 106 is disposed or located along a centerline (or equator) of that grid. The super one-dimensional computational unit 116 is referred to alternatively herein as “super one-dimensional unit 116.”

Referring again to FIG. 1, super tile 108 includes multiple individual compute tiles 110A, 110B, 110C, and 110D, super tile 112 includes multiple individual compute tiles 114A, 114B, 114C, and 114D, and super one-dimensional unit 116 includes individual one-dimensional compute units 118-0 and 118-1. Each of super tile 108, 112 can include more or fewer computes tiles 110, 114. Similarly, super one-dimensional unit 116 can include more or fewer individual one-dimensional units 118. The super tiles, super one-dimensional compute units, and communication blocks are described in detail below.

The circuit 100 is referred to alternatively herein as “system 100.” The circuit architecture can be used in a special-purpose processor, such as a machine-learning (ML) hardware accelerator configured to accelerate computations of an example ML model. For example, an ASIC may be designed to perform ML model operations such as, recognizing objects in images, machine translation, speech recognition, or other ML tasks.

In some implementations, circuit 100 is a hardware accelerator configured to implement an example neural network that includes multiple neural network layers. For example, the hardware accelerator can accelerate computations for a neural network model, such as computations of a layer of an artificial neural network. In some other implementations, circuit 100 is an example system 100 having multiple hardware accelerators that are each configured to implement a multi-layer neural network or implement various individual neural network layers of a multi-layer neural network. The hardware accelerators can be implemented as application-specific integrated circuit that are optimized to execute a particular type of ML task using a multi-layer neural network.

In general, circuit 100 can include processors (e.g., central processing units (CPUs), graphics processing units (GPUs), special-purpose processors, etc.), memory, and/or data storage devices that collectively form processing resources used to execute different ML functions such as training and inference computations. For example, each super tile 108, 112 can be associated with an individual special-purpose processor that includes one or more CPUs or GPUs and one or more processor cores. In some examples, each super tile 108, 112 corresponds to a respective processor core of a multi-core special-purpose processor, such as neural network processor configured to implement a neural network or a deep neural network.

Each super tile 108, 112, and/or each compute tile 110A/B/C/D, 114 A/B/C/D can include local memory. In some cases, each super tile 108, 112 is configured to execute multiple compute threads and includes a unified (or shared) memory that is accessible by each compute tile 110, 114 of a corresponding super tile 108, 112. For example, a super tile 108 can execute a compute thread based on data obtained from: i) a shared memory of the super tile, ii) a one-dimensional compute unit, iii) another super tile 112, iv) externally from a host, or v) a combinations of these data sources. In one implementation, the data may be obtained by a first super tile 108 from a first memory, e.g., a shared memory, which is local to that super tile 108, whereas in another implementation the data may be obtained by the first super tile 108 from a second, different memory that is external to that super tile 108. The second memory may be local to a different super tile, such as super tile 112, or local to a super one-dimensional compute unit 116. In some cases, the data is obtained from multiple distinct second memories, such as a respective memory local to a specific super one-dimensional compute units 116 or a system memory accessible by the host and external to at least the super tiles of circuit 100.

The circuit architecture of FIG. 1 includes, or provides an example of, special purpose logic circuitry. For example, one or more of the compute tiles includes special-purpose circuitry configured to perform operations, such as multiplication and addition operations. In particular, each compute tile 110, 114 can include a computational array of cells, in which each cell is configured to perform mathematical operations. In some implementations, the compute tiles 110, 114 are arranged in a grid pattern and may be described with reference to a particular dimension of the integrated circuit 100, a particular dimension of its super tile 108, 112, or both.

For example, the compute tiles 110, 114 can be arranged along a first dimension (e.g., row dimension) or along a second dimension 103 (e.g., columns). In some implementations, a first subset of compute tiles is described with reference to a first dimension of the integrated circuit (or super tile), whereas a second subset of compute tiles is described with reference to a second dimension of the integrated circuit (or super tile). In at least one instance, the first dimension and the second dimension may be the same dimension.

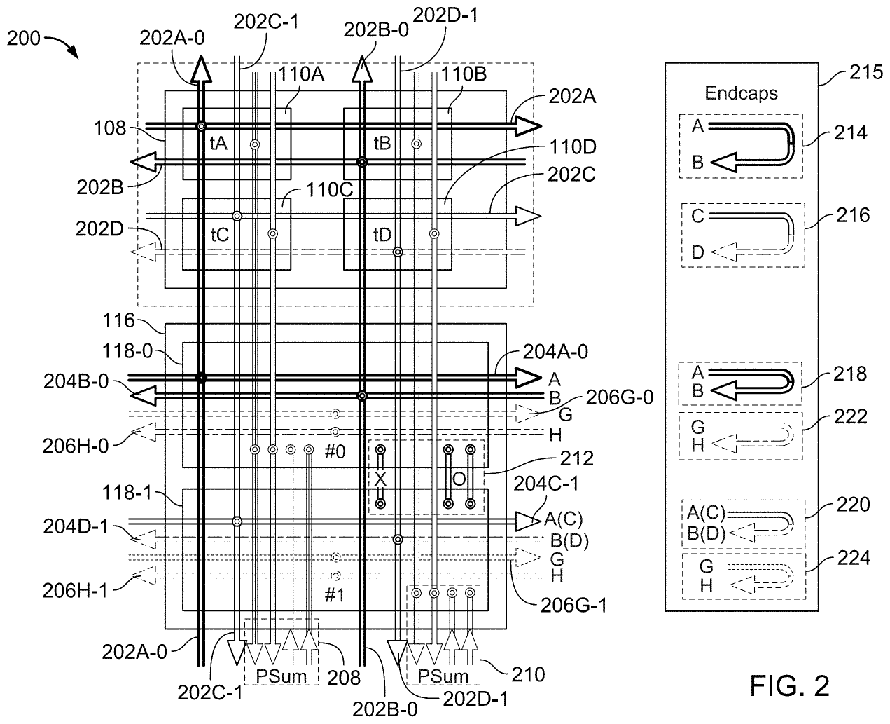

FIG. 2 is a block diagram showing an example of a dynamically configurable routing network 200 of the integrated circuit of FIG. 1. In some implementations, the network 200 is included in a single integrated circuit 100 or configured to couple multiple individual integrated circuits in a system 100.

The routing network 200 is dynamically configurable and includes multiple sets of controllable bus lines. The controllable bus lines can represent data paths that provide interconnections between the array of super tiles 102, 104 and the array of super one-dimensional compute units 106. The routing network 200 includes a set of data paths 202 and a set of data paths 204 (e.g., controllable bus lines). Each of these sets of data paths 202, 204 is configured to couple a given one-dimensional unit 118 unit and a particular compute tile 110, 114 such that data values are routable between the given one-dimensional unit 116 and the particular compute tile 110, 114.

Each of the data paths 202, 204 can includes a respective subset of data paths that can couple units along different dimensions of the integrated circuit. Each of the data paths 202, 204 includes a subset of data paths that couple a first super tile (or tile within the first super tile) and a second, different super tile (or tile within the second super tile). Additionally, each of the data paths 202, 204 includes a subset of data paths that couple a tile within a super tile to a one-dimensional unit in an adjacent or neighboring super one-dimensional unit. In general, the data paths are bus lines that can directly couple the first and second super tiles (or tiles) or indirectly couple the first and second super tiles (or tiles) by way of one-dimensional units 118 that are intermediate the first and second super tiles (or tiles).

For example, the set of data paths 202 includes bus line 202A, bus line 202B, bus line 202C, and bus line 202D, where bus line 202A directly couples tile 110A to a corresponding tile A in another super tile 108 (e.g., a neighboring or adjacent super tile), bus line 202B directly couples tile 110B to a corresponding tile B in another super tile 108, bus line 202C directly couples tile 110C to a corresponding tile C in another super tile 108, and bus line 202D directly couples tile 110D to a corresponding tile D in another super tile 108. In some implementations, each of bus lines 202A, 202B, 202C, and 202D provide direct coupling along a row dimension of the integrated circuit 100. In some other implementations, some (or all) of bus lines 202A, 202B, 202C, and 202D may be configured to provide direct, or indirect, coupling along a column dimension of the integrated circuit 100.

The set of data paths 202 also includes bus line 202A-0, bus line 202B-0, bus line 202C-1, and bus line 202D-1. In the example of FIG. 2, bus line 202A-0 directly couples tile 110A to one-dimensional unit 118-0 of super one-dimensional unit 116 and bus line 202B-0 directly couples tile 110B to one-dimensional unit 118-0, whereas bus line 202C-1 directly couples tile 110C to one-dimensional unit 118-1 and bus line 202D-1 directly couples tile 110D to one-dimensional unit 118-1. In some implementations, each of bus lines 202A-0, 202B-0, 202C-1, and 202D-1 provide direct coupling along a column dimension of the integrated circuit 100. In some other implementations, some (or all) of bus lines 202A-0, 202B-0, 202C-1, and 202D-1 may be configured to provide direct, or indirect, coupling along a row dimension of the integrated circuit 100.

The set of data paths 204 correspond generally to connections or couplings between a first super tile (or tile within the first super tile) and a second, different super tile (or tile within the second super tile) by way of one or more one-dimensional units 118 that are intermediate the first and second super tiles. The set of data paths 204 include bus line 204A-0, bus line 204B-0, bus line 204C-1, and bus line 204D-1, where bus line 204A-0 indirectly couples tile 110A to a corresponding tile A in another super tile 108 (e.g., a neighboring or adjacent super tile) by way of one-dimensional unit 118-0, bus line 204B-0 indirectly couples tile 110B to a corresponding tile B in another super tile 108 by way of one-dimensional unit 118-0, bus line 204C-1 indirectly couples tile 110C to a corresponding tile C in another super tile 108 by way of one-dimensional unit 118-1, and bus line 204D-1 indirectly couples tile 110D to a corresponding tile D in another super tile 108 by way of one-dimensional unit 118-1.

In some implementations, each of bus lines 204A-0, 204B-0, 204C-1, and 204D-1 provide direct coupling along a row dimension of the integrated circuit 100, where bus lines 204A-0 and 204C-1 route data in an eastward direction along the row dimension and bus lines 204B-0 and 204D-1 route data in a westward direction along the row dimension. In some other implementations, some (or all) of bus lines 204A-0, 204B-0, 204C-1, and 204D-1 may be configured to provide direct, or indirect, coupling along a column dimension of the integrated circuit 100 and in an eastward or westward direction.

The routing network 200 further includes a set of data paths 206 (e.g., controllable bus lines). The set of data paths 206 correspond generally to connections or couplings between one or more super one-dimensional units 116 or between a respective one-dimensional unit 118 in at least two different super one-dimensional units 116. The set of data paths 206 includes bus line 206G-0, bus line 204H-0, bus line 206G-1, and bus line 204H-1. In the example of FIG. 2, bus lines 206G-0 and 206H-0 directly couple a first one-dimensional unit 118-0 of a first super one-dimensional unit 116 with a second one-dimensional unit 118-0 of a second, different super one-dimensional unit 116, whereas bus lines 206G-1 and 206H-1 directly couple a first one-dimensional unit 118-1 of the first super one-dimensional unit 116 with a second one-dimensional unit 118-1 of the second, different super one-dimensional unit 116.

In some implementations, each of bus lines 206G-0, 206H-0, 206G-1, and 206H-1 provide direct coupling along a row dimension of the integrated circuit 100, where bus lines 206G-0 and 206G-1 route data in an eastward direction along the row dimension and bus lines 206H-0 and 206H-1 route data in a westward direction along the row dimension. In some other implementations, some (or all) of bus lines 206G-0, 206H-0, 206G-1, and 206H-1 may be configured to provide direct, or indirect, coupling along a column dimension of the integrated circuit 100 and in an eastward or westward direction.

The routing network 200 further includes a set of data paths 208 and a set of data paths 210 (e.g., controllable bus lines). Each of these sets of data paths 208, 210 is configured to couple a given one-dimensional unit 118 unit and a particular compute tile 110, 114 such that data values are routable between the given one-dimensional unit 118 and the particular compute tile 110, 114. For example, data paths 208 are a first set of data paths couple the one-dimensional unit 118-0 and a first subset of compute tiles (e.g., tile 110A and 110C), whereas data paths 210 are a second set of data paths that couple the one-dimensional unit 118-1 and a second subset of compute tiles (e.g., tile 110B and 110D).

The illustration for FIG. 2 also includes an example bus map 215, which is shown for clarity but is not included in the system 100 or the routing network 200. The bus map 215 includes endcap indicators for various controllable bus lines of routing network 200. An indicator 214 corresponds to an endcap for bus lines 202A and 202B. An indicator 216 corresponds to an endcap for bus lines 202C and 202D. An indicator 218 corresponds to an endcap for bus lines 204A-0 and 204B-0. An indicator 220 corresponds to an endcap for bus lines 204C-1 and 204D-1. An indicator 222 corresponds to an endcap for bus lines 206G-0 and 206H-0. An indicator 224 corresponds to an endcap for bus lines 206G-1 and 206H-1.

As shown in the example of FIG. 2, the routing network 200 provides interconnections between: i) a super tile 108, 112 and a super one-dimensional compute unit 116; ii) an individual compute tile 110, 114 and an individual one-dimensional compute unit 118-0, 118-1; iii) two or more super tiles 108, 112; iv) two or more super one-dimensional compute units 116; or v) various combinations of these. For example, the routing network 200 also provides interconnections between individual compute tiles 110, 114 of a super tile 108, 112 and between individual one-dimensional compute units 118-0, 118-1 of a super one-dimensional compute unit 116.

As described in detail below, each of the data paths 202 and 204 can be general-purpose bus lines, whereas each of the data paths 206, 208, 210 can be special-purpose bus lines. The general-purpose bus lines of data paths 202 and 204 are optimized to provide general connectivity between various combinations of units across the array 102, array 104, and array 106. Some (or all) of data paths 206, 208, and 210 can be special-purpose bus lines that are optimized to provide single purpose routing of different types of data values. For example, the set of data paths 206 can provide connectivity between various combinations of one-dimensional units 118-0, 118-1 across an array of super one-dimensional compute units 106.

In some implementations, each of the data paths 208, 210 is a specialized high-bandwidth controllable bus line that routes certain types of input data from a particular compute tile 110 or subset of compute tiles 110, along a given dimension, to a one-dimensional unit 118. In some implementations, the input data can be intermediate values computed at particular steps in a sequence of computations that are executed to process data for a ML workload. For example, the intermediate values can be partial sums that are used to perform dot product accumulations. The accumulations may be for generating an output of a neural network layer, such as a convolutional neural network layer or some other operation of the ML workload.

Each of the compute tiles 110, 114 can include an array (e.g., a systolic array) of compute cells, such as multiply-accumulate cells (MACs) that are used to perform multiplication and addition operations. For example, each of the compute tiles 110, 114 can include one or more matrix computation units operable to perform matrix multiplication. Each matrix computation unit (“matrix unit”) can include a systolic array or multi-dimensional array of compute cells, e.g., arranged in a row, column format. In some implementations, each of the compute cells of the matrix unit includes respective addition and multiplication circuitry, and each matrix unit includes respective normalization circuitry for normalizing a set of accumulated values and respective pooling circuitry for pooling a set of accumulated values.

Some (or all) of the compute tiles 110 can include memory for storing control information and/or a local controller that can execute the control information. Based on the control information, the tile or controller can generate control signals to perform calculations on input data, such as weights and inputs (or activation inputs) to be processed at a neural network layer. In some implementations, the integrated circuit is a neural network processor configured to perform deterministic operations based on a set of predetermined instructions. The predetermined instructions are executed using one or more sets of clock signals and may be passed as an instruction set to a given compute tile or be included in portion of control information provided to a given compute tile 110 or super tile.

Each super tile 108, 112 can execute multiple different computations at the same time. For example, a super tile with two individual compute tiles can execute two different computations in parallel, a super tile with four compute tiles can execute four different computations in parallel, a super tile with six compute tiles can execute six different computations in parallel, and so on. The computations may be a group of computations for a single neural network layer or a group of computations for multiple neural network layers. In some implementations, the computations may be split or staggered at a single compute tile such that an individual compute tile can execute two or more computations based on design preference.

The computations can be time delay multiplexed. For example, during clock cycles 0, 4, and 8, a compute tile 110 may execute one computation, whereas at clock cycles 1, 5, and 9 the same (or a different) compute tile can execute a different computation. The compute tile may generate or receive a clock signal corresponding to one or more clock cycles. In some implementations, the results of the computation are passed to a corresponding one-dimensional unit 118 and may arrive at the one-dimensional unit 118 in an interleaved manner. As described below, the one-dimensional unit 118 can include an accumRAM (e.g., dual-ported RAM) that manages and handles the routing or accumulation of interleaved sums.

The compute tile 110 can also execute various portions of the control information concurrent with performing calculations on the input data. In some implementations, the system 100 includes high-level controller that is operable to generate control information such as control values or signals for configuring controllable data and bus lines of an integrated circuit 100 during operation of the circuit 100 so that data can be moved efficiently around the circuit 100 to accomplish a given machine-learning task. The controller may be external to the integrated circuit 100 or internal to circuit 100 and co-located with one or more of arrays 102, 104, 106.

Each of the one-dimensional units 118 can be vector processing/computation units (“vector units”) that can execute various types of operations and computations on vector (or scalar) values. Each of the vector units 118 is configured to communicate with a respective multi-dimensional array of compute cells in a compute tile 110, 114. The vector unit 118-0 communicates with a respective array of compute cells in compute tile 110A and 110C using bus lines of data paths 208, whereas vector unit 118-1 communicates with a respective array of compute cells in compute tile 110B and 110D using bus lines of data paths 210. For example, the vector unit 118-0 can use the bus lines of data paths 208 to receive intermediate values or partials sums that are generated at a corresponding compute tile 110A and 110C. Likewise, the vector unit 118-1 can use the bus lines of data paths 210 to receive intermediate values or partials sums that are generated at a corresponding compute tile 110B and 110D. The partial sums may be generated when the integrated circuit 100 performs neural network computations to generate an output of a neural network layer.

In some implementations, the controllable bus lines of the data paths 208, 210 are dedicated, special-purpose partial-sum buses that are specialized to provide improved energy efficiency relative to other data buses at least based on the single directional flow of partial sum values that are routed via the dedicated buses. For example, the integrated circuit 100 can be configured to such that the partial-sum buses of data paths 208, 210 only run along a particular dimension of the circuit, such as from north to south (e.g., along a column dimension). Relative to other multi-dimensional data lines, this dedicated one-dimensional routing requires less control/circuit logic and, so, is more energy efficient relative to other approaches.

In the example of FIG. 2, each of data paths 208, 210 include two partial sum buses for obtaining or transferring partial sums from north super tiles and two partial sum buses for obtaining or transferring partial sums from south super tiles. For example, data path 208 includes two bus lines that are configured to move data values from super tiles 108 (north super tiles) to vector unit 118-0 and two bus lines that are configured to move data values from super tiles 112 (south super tiles) to vector unit 118-0. Similarly, data path 210 includes two bus lines that are configured to move data values from super tiles 108 (north super tiles) to vector unit 118-1 and two bus lines that are configured to move data values from super tiles 112 (south super tiles) to vector unit 118-1.

The routing network 200 further includes a set of data paths 212 (e.g., controllable bus lines). More specifically, data paths 212 include special-purpose controllable bus lines 212-X and 212-O (x2) that route certain types of data along a given dimension of a circuit, between one-dimensional units 118 in a super one-dimensional unit 116. The data can be intermediate values (e.g., partial sums) computed for a ML workload. In some implementations, data paths 212 are vector unit interconnects that are configured to couple one-dimensional unit 118-0 and one-dimensional unit 118-1 such that data values are routable between a set of vector units 118.

The system 100 uses the data paths 212 to expand operations across two, rather one, vector unit 118. In some implementations, the system 100 can perform an accumulation operation to generate a second set of accumulated values using a first vector unit 118-0 and concurrently apply an activation function to a first set of accumulated values that were previously using the first vector unit 118-0. For example, over a set of clock cycles, vector unit 118-0 can compute the second set of accumulated values and stream the second set of accumulated values to unit 118-1 via a bus line of data path 212. Over the same set of clock cycles, vector unit 118-1 can generate output activations in response to applying an activation function to each value in the first set of accumulated values. The vector unit 118 can also stream or route the output activations to: i) a memory of system 100, ii) vector unit 118-0 via data paths 212, iii) another vector unit 118, e.g., via bus lines 206H-1/206G-1, or iv) another compute tile 110, 114, e.g., via 204C-1/204D-1.

The data paths 212 allow for multiple partial sums to arrive at a given vector unit 118 and for performing different types of arithmetic operations on those partial sums. As described in more detail below, using at least the bus lines 212-X, 212-O of data paths 212, the system 100 can partition large hardware grids of the arrays 102, 104, and/or array 106 into smaller hardware blocks (or segments) to further streamline and dynamically optimize the system's processing of tensors or matrices of varying sizes and dimensions. In some cases, the partitioning of the hardware grids may be particularly efficient for processing reduced size tensors or matrices.

In some implementations, individual one-dimensional units 118-0, 118-1 of a super one-dimensional unit 116 are tightly coupled at least based on the configuration of the data/bus line connections 212-X and 212-O. For example, vector unit 118-0 and vector unit 118-1 can be “tightly coupled” when a distance between the respective units or between respective ends of an X & O connection (212) is between 0.001 microns and 0.1 microns, between 0.01 microns and 10 microns, or between 0.1 microns and 100 microns. In addition to supporting the tight coupling of at least two vector units 118, the X & O connections of data paths 212 provide for additional bandwidth for routing data between vector unit 118-0 and vector unit 118-1. The additional or increased bandwidth allows for devoting more computation to a single computer vision problem or ML task.

In some implementations, two or more one-dimensional units 118 can be coupled, via routing network 200, to form a larger special-purpose processing device to improve computing latencies for a given ML task. Hence, data connections of system 100 and routing network 200 are configurable and controllable such that two or more one-dimensional units 118 (and/or compute tiles 110, 114) can work in tandem to accomplish a common computational goal. For example, vector units 118-0, 118-1 of a first super one-dimensional unit 116 can work in tandem with each vector unit 118 in a left, adjacent super one-dimensional unit 116 as well as with each vector unit 118 in a right, adjacent super one-dimensional unit 116. In some implementations, the routing network 200 can dynamically configure its data connections such that the first super one-dimensional unit 116, and vector units 118 of multiple, second super one-dimensional units 116 can communicate and work in tandem to accomplish a common computational goal.

Each of the vector units 118-0, 118-1 is configured to perform respective reduction operations on one or more sets of values (e.g., partial sums) that are output by a respective compute cell or multi-dimensional array of compute cells in each of the compute tiles 110, 114. For example, the bus lines 206G and 206H of data paths 206 can allow for additional connectivity of one or more vector units 118 and provide horizontal (or row dimension) data routing in support of reduction operations. In some implementations, the bus lines 206G and 206H are dynamically configurable to pass data to an additional vector unit 118 to support reduction operations on two or more sets of vectors. For example, the operations can include summation operations or max operations across a vector to generate a single result or output value (e.g., reduce to a scalar based on max or summation). In some implementations, the vector units 118 performs these operations when system 100 executes neural network computations to generate a layer output or performs some other type of machine-learning operation.

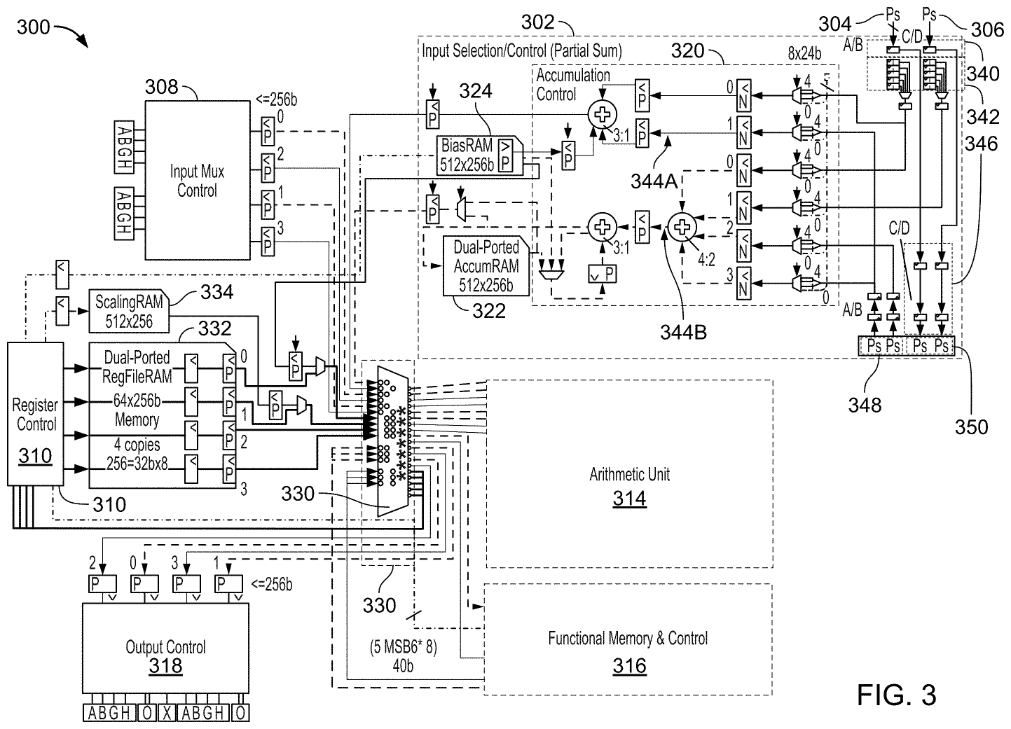

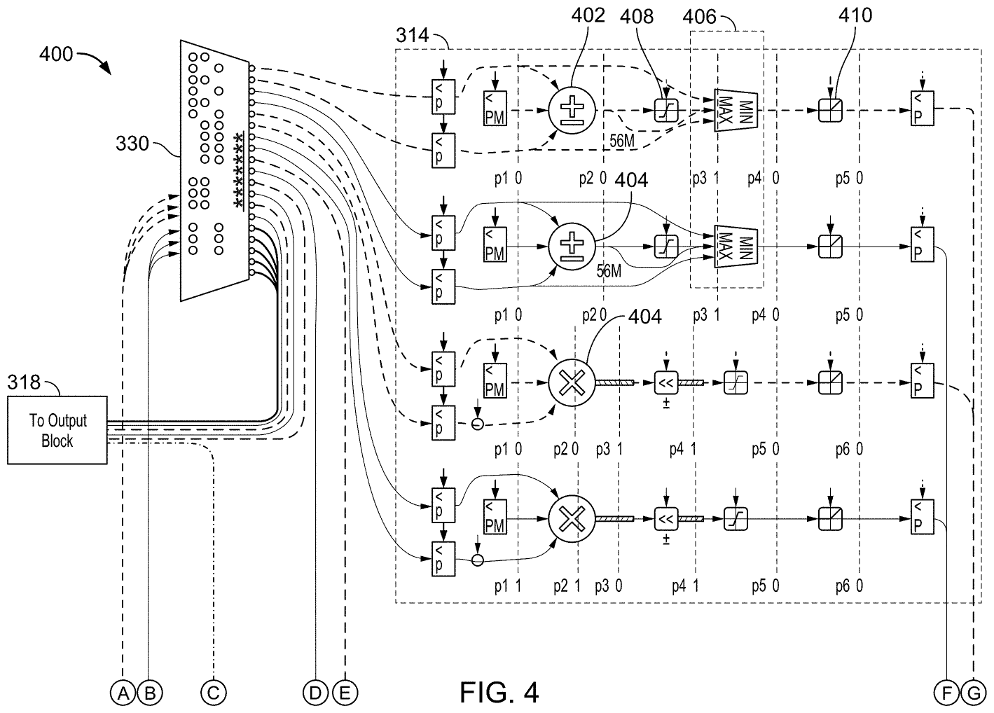

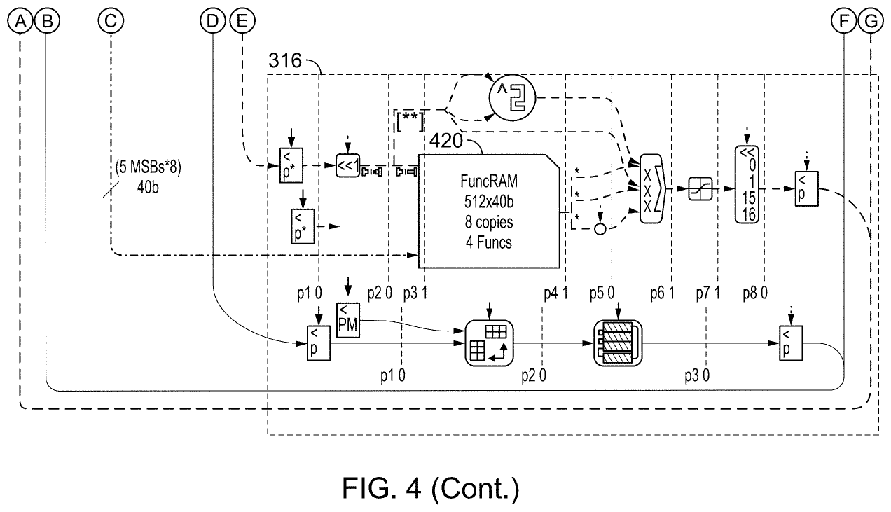

FIG. 3 illustrates an example internal hardware architecture 300 of a one-dimensional computational unit 118 (or vector unit 118). The architecture 300 includes an input selection/control block 302 (“input control 302”), an input mux control block 308 (“mux control 308”), a register control block 310 (“register control 310”), an arithmetic unit 314, a function & memory control block 316 (“funcMEM control 316”), and an output control block 318 (“output control 318”). Each of these items of architecture 300 can represent a respective hardware block or logical operator of an integrated circuit included in a one-dimensional unit 118. The arithmetic unit 314 and funcMEM control 316 are described with reference to FIG. 4.

The input control 302 corresponds to logical and hardware-based control circuitry for selecting and routing data values 304, 306 received at an example vector unit 118. In some implementations, data values 304, 306 are partial sums, with values 304 corresponding to data received from compute tiles A/B and values 306 corresponding to data received from compute tiles C/D. In some other implementations, data values 304, 306 are initial or intermediate values computed for a particular ML workload. Whether partial sums or other types of data, the values 304 and 306 will still correspond to data received from compute tiles A/B and C/D, respectively.

The input control 302 includes an accumulation control 320, a set of registers 340, and a set of registers 342. The first set of registers 340 can be configured as bypass registers to store intermediate or partial sum values that are passed from an initial vector unit 118 to a subsequent vector unit 118 without being operated on by the initial vector unit 118. In other words, the bypass registers 340 enable data values to bypass processing at a given vector unit 118. For example, over one or more clock cycles, data values that are stored at bypass registers 340 can be shifted or routed to a subsequent vector unit 118 via partial sum bypass connection 346. The set of registers 342 are configurable delay registers that allow for synchronizing receipt of partial sum data values 304, 306 with other operations across one or more vector units 118 or one or more compute tiles 110.

As shown at FIG. 1, an example “equator” line can define a north and south hemisphere of an integrated circuit 100, where the north hemisphere includes array 102 and the south hemisphere includes array 104. For certain simultaneous operations that use various sets of partial sums, it may take longer for partial sums to arrive from a non-local hemisphere relative to partial sums that are computed from a local hemisphere. This is at least because data values (e.g., accumulated values) computed using a tile/super tile in a non-local hemisphere may have to travel through the one-dimensional unit 118 in that non-local hemisphere before arriving at the processing one-dimensional unit 118 in the local hemisphere.

For example, the system 100 can simultaneously initiate an ML/neural network computation using compute tiles in different hemispheres, such as a compute tile 110 (e.g., tile C) and a compute tile 114 (e.g., tile B). In this example, compute tile 110C is in a local hemisphere and has a direct coupling/connection to vector unit 118-0 in its local hemisphere, whereas compute tile 114B is in a non-local hemisphere, relative to compute tile 110C, and has an indirect coupling/connection to the vector unit 118-0.

When executing the ML/neural network computation, the vector unit 118-0 that is directly coupled to compute tile 110C in the local hemisphere can require data values, such as partial sums, that were computed at the non-local compute tile 114B. In some implementations, the sets of registers 342 are used to implement a delay pipeline that applies asymmetric delay to partial sums arriving from a local hemisphere. For example, the system 100 can detect that data values computed at compute tile 114B, or another non-local resource, are (or will be) required at vector unit 118-0 in the local hemisphere for a subsequent (or current) operation. In response to this detection, the system 100 can compute a delay factor and configure one or more delay registers 342 to synchronize receipt of partial sum data values 304, 306 at the local hemisphere from the non-local hemisphere based on the delay factor. A factor of delay imparted on an operation via the delay registers 342 may be measured in clock cycles.

The system 100 can synchronize receipt at least by using the delay registers 342 to delay routing of data values in the local hemisphere until the required values arrive from the non-local hemisphere. This corresponds to the asymmetric delay discussed above. For example, to account for delays (e.g., wire delay or latency) in receiving partial sums from a non-local resource, the delay registers 342 are used to ensure the arrival of data values from local and non-local resources is synchronized with the overall execution of a subsequent or current operation that requires those values.

The input control 302 includes partial-sum inputs 348 and partial-sum outputs 350. The partial-sum inputs 348 correspond to the controllable bus lines of data path 208 or 210 that supply input data/values (e.g., partial sums) into a particular one-dimensional unit 118, whereas the partial-sum outputs 350 correspond to the controllable bus lines of data path 208 or 210 that send output data/values (e.g., partial sums) from the particular one-dimensional unit 118. In some implementations, the partial-sum inputs 348 supply input data into a vector unit 118 from different vector units 118 in a non-local hemisphere, and the partial-sum outputs 350 send output data from the vector unit 118 to different vector units 118 in the non-local hemisphere. In some other implementations, the partial-sum inputs 348 supply input data into a vector unit 118 from tiles in the non-local hemisphere, and the partial-sum outputs 350 send output data from the vector unit 118 to tiles in the non-local hemisphere.

The accumulation control 320 includes a first processing pipeline 344A and a second processing pipeline 344B. In some implementations, first processing pipeline 344A is used for smaller accumulations or data processing associated with smaller tensors/matrices, such as matrices processed only at tile A or only tile B, whereas the second processing pipeline 344B is used for larger accumulations or data processing associated with much larger tensors/matrices, such as matrices processed at tiles A and C or tiles B and D.

The input control 302 includes an accumulation memory 322 and a bias memory 324. Each of the accumulation memory 322 and the bias memory 324 can be a random-access memory (RAM) or some other related temporary, cache, or volatile memory of a computer system or data storage device. The bias memory 324 is used to initialize and/or bias a particular accumulation operation that uses data values stored in the accumulation memory 322. For example, the bias memory 324 can store a constant or some other type of value that can be used to bias the accumulation memory 322 or accumulation operation. The accumulation memory 322 cooperates with the bias memory 324 as well as other circuitry and logic operators of the input control 302 to perform one or more data accumulation, data storage, and data routing functions. For example, the accumulation memory 322 can interact with an adder, a multiplexer, and a register of the accumulation control 320 to perform various accumulation operations.

The accumulation memory 322 can route and store data values arriving on different clocks signals, for example, based on one or more control signals. In some implementations, the control signals are generated by a local control logic of the one-dimensional unit 118 or a higher-level system controller that is external to the one-dimensional unit 118. The data values arriving on different clocks signals can be associated with different computations, such as computations for a common or distinct machine-learning task.

In some implementations, the overall logical and hardware architectures 300 used in a super one-dimensional unit 116 allows for concurrent performance of at least two independent accumulation operations at a single super one-dimensional unit 116. In some other implementations, the logical and hardware architecture 300 used in an individual one-dimensional unit 118 allows for concurrent performance of at least two independent accumulation operations at that single one-dimensional unit 118. For example, each of a one-dimensional unit 118 and a super one-dimensional unit 116 can perform distinct accumulations in parallel.

The support these independent accumulation operations, the accumulation memory 322 can be used to interleave one or more values with reference to one or more clock cycles. For example, the accumulation memory 322 can be used to interleave one or more values that arrive at clock cycle 0 with one or more values that arrive at clock cycle 4, and then interleave those values with one or more values that arrive at clock cycle 8, and so on. In this manner, values arriving on clock cycles 0, 4, and 8 may be associated with a one independent accumulation operation, whereas values arriving at an iterative sequence of other clock cycles may be associated with a different independent accumulation operation. In some implementations, the ability to interleave values in this manner has specific application to optimizing batch processing of layer inputs across a neural network graph.

Each of the one-dimensional unit 118 can store, generate, and/or process control information and the system 100 can manage operations for some (or all) of the control blocks of the internal architecture 300 based on this control information. The control information can be control values, associated control signals, executable instructions/commands, or a combination of these. In some implementations, each vector unit 118 includes memory for storing a portion of control information and/or a local controller that can execute the control information. Based on the control information, the vector unit 118 can generate signals to control and execute operations involving at least mux control 308, register control 310, output control 318, and multiplexor 330.

The control information includes control values or signals for configuring the controllable data lines of the one-dimensional unit 118 during operation of the one-dimensional unit 116 so that data can be moved around the one-dimensional unit 116. For example, the control information can be provided to the mux control 308, register control 310, output control 318, and multiplexor 330 in the form of control signals to control and manage the data lines and more granular circuitry, such as registers, operators, and bus lines, that are included in, or connected to, the various control blocks of the one-dimensional unit 118.

In some implementations, the control information includes control signals that direct multiplexer 330 to transfer data from the input control 302, mux control 308, register memory 332, or scaling memory 334 to arithmetic unit 314, funcMEM control 316, and output control 318, as well as to other circuitry within system 100. The control information can also cause the register control 310 to generate control signals that direct register memory 332 and/or scaling memory 334 to transmit register or scaling values to multiplexer 330. Based on these control signals, the multiplexer 330 can forward these data values from the register memory 332 and/or scaling memory 334 to the arithmetic unit 314 and funcMEM control 316 (described below) to support arithmetic operations of the one-dimensional unit 118.

FIG. 4 illustrates an example internal hardware layout of an arithmetic unit and a functional memory block of the one-dimensional computational unit of FIG. 3. The arithmetic unit 314 units includes a plus-minus operator 402 and multiplication operator 404. The arithmetic unit 314 uses one or both of these operators 402, 404 to perform operations related to function approximation or application of activation functions to a set of values. The arithmetic unit 314 includes a min/max operator 406 that is operable to identify a minimum or maximum value from a set of values and a function unit 408 that is operable to execute a clipping function on one or more values, such as accumulated values.

In some implementations, the function unit 408 enforces upper and lower bound thresholds. For example, the function unit 408 is operable to clip or reduce a value of an output to prevent overflow with regard to an operation involving that output. The arithmetic unit 314 includes another function unit 410 that is operable to apply a function to an accumulate value to generate an activation value. For example, the function unit 410 is operable to apply a RelU function to an accumulated value. In some implementations, the arithmetic unit 314 can approximate and/or store one or more functions, such as a sin, cosine, sigmoid, or tan(h) function. In general, the arithmetic unit 314 can approximate one or more unary functions (e.g., activation functions).

The funcMEM control 316 includes an example functional memory unit 420 and is configured to perform various types of arithmetic operations on sets of values. For example, the funcMEM control 316 is used to perform interpolation of data values obtained from a loadable table of values accessible at the integrated circuit. In some implementations, the interpolation operation is a linear, piecewise, or quadratic interpolation that is performed as part of an activation computation for a neural network. The loadable table may be accessed locally or externally. For example, the loadable table may be stored locally in a memory of the integrated circuit or passed to a vector unit or compute tile of the circuit from a host device or from another integrated circuit.

In some implementations, the funcMEM control 316 is included in the arithmetic unit 314 as a sub-circuit of the arithmetic unit 314. In some other implementations, the arithmetic unit 314 and funcMEM control 316 are integrated as an individual function/arithmetic unit. In both cases, the arithmetic unit 314 and funcMEM control 316 cooperate to perform computations for application of a function in the context of a neural network processor chip.

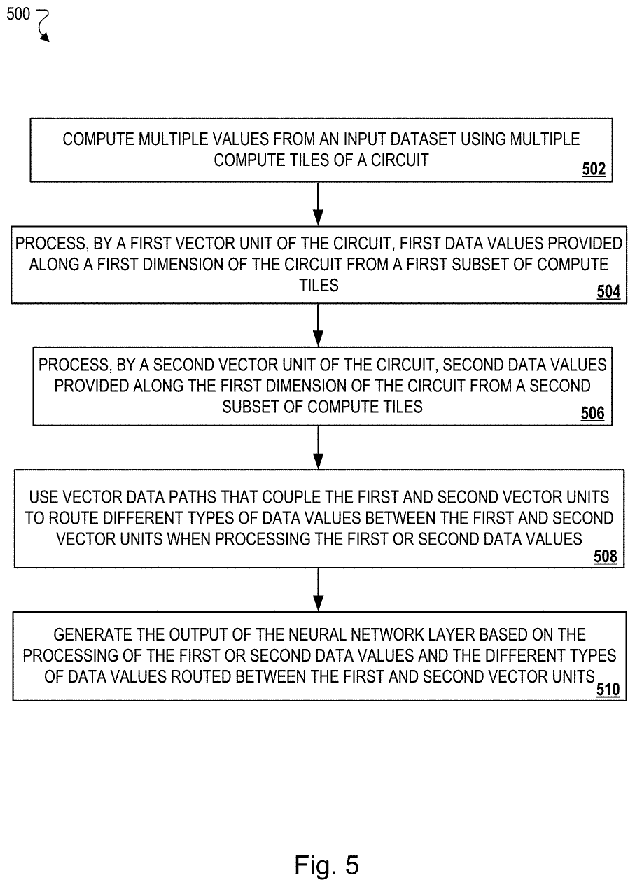

FIG. 5 is a flow diagram that illustrates an example process 500 for generating an output of a neural network layer using at least one application-specific integrated circuit of system 100, such as a machine-learning hardware accelerator. Process 500 can be implemented or executed using the system 100 described above. Descriptions of process 500 may reference the above-mentioned computing resources of system 100. The steps or actions of process 500 may be enabled by programmed firmware, or software instructions, which are executable by one or more processors, e.g., neural network processors, of the devices and resources described in this document.

Referring now to process 500, system 100 computes one or more sets of data values using one or more compute tiles 110 within a given tile block 102, 104 at the integrated circuit (502). In general, each of the compute tiles 110 are configured to process data that is used to generate an output of a neural network layer. For example, an input dataset may be derived from the data to be processed, and the sets of data values may be computed from this input dataset. The input dataset can include one or more batches of inputs to be processed at one or more neural network layers of a multi-layer neural network. The input dataset can also include one or more sets of weights for a neural network layer through which a batch of inputs will be processed.

As described above, each super tile 108 (or single compute tile 110) is configured to independently execute computations (e.g., neural network computations) to process a batch of inputs through one or more neural network layers using a corresponding set of weights for that layer. For example, the computations may be required to process data for a machine-learning workload or to execute specific tasks of the workload, such as a computer vision task. Computations performed at a compute tile 110 to process inputs through one or more neural network layers may include a multiplication of a first set of data values (e.g., inputs or activations) with a second set of data values (e.g., weights). For example, the computation can include multiplying an input or activation value with a weight value on one or more cycles and performing an accumulation of products over many cycles.

The system 100 processes first data values using a first vector unit of the circuit (504). The first data values are provided along a first dimension of the integrated circuit from a first subset of compute tiles 110, such as tiles 110A and 110B. The system 100 processes second data values using a second vector unit of the circuit (506). The second data values are also provided along the first dimension of the circuit by a second subset of compute tiles, such as tiles 110C and 110D. In some implementations, the first and second subset of compute tiles 110 are from the same super tile 108. In some other implementations, the first and second subset of compute tiles 110 are from different super tiles 108.

In some implementations, each tile A (e.g., compute tile 110A, 114A) across multiple super tiles 108, 112 all share a common or general-purpose bus line and are all coupled or connected to a specific one-dimensional unit 118 in a given super one-dimensional unit 116. This also applies to each of tiles B, tile C, and tile D. For example, each tile C (e.g., compute tile 110C, 114C) across super tiles 108, 112 all share a common/general-purpose bus line and are all coupled to a specific one-dimensional unit 118 in a given super one-dimensional unit 116. The specific one-dimensional unit may be a #0 (north) one-dimensional/vector unit or a #1 (south) one-dimensional/vector unit. In some instances, a respective set of partial sums from tiles A and B are routed to a first one-dimensional unit 118, whereas a respective set of partial sums from tiles C and D are routed to a second, different one-dimensional unit 118. Each of the first and second one-dimensional unit 118 can combine the respective sets of partial sums or operate on them separately.

The system 100 uses vector data paths that couple the first and second vector units to route different types of data values between the first and second vector units (508). In some implementations, the system 100 performs this routing of data values via the vector data paths as part of, or current with, the processing of the first data values, the second data values, or both. For example, data paths 208 are a first set of vector data paths couple the vector unit 118-0 and a first subset of compute tiles (e.g., tile 110A and 110C), whereas data paths 210 are a second set of vector data paths that couple the vector unit 118-1 and a second subset of compute tiles (e.g., tile 110B and 110D). In some implementations, each of the vector data paths 208, 210 is a specialized high-bandwidth controllable bus line that routes certain types of input data (e.g., partial sums) from a particular compute tile 110 or subset of compute tiles 110, along a given dimension, to a vector unit 118.

The system 100 generates the output of the neural network layer based on the processing of the first or second data values and the different types of data values that are routed between the first and second vector units (510). For example, compute tiles and the first and second vector units 118-0, 118-1 cooperate to generate respective outputs for each layer of the multiple neural network layers based on data values that are routed using the first and second set of data paths 202, 204, 206, 212 and/or the different sets of vector data paths 208, 210.

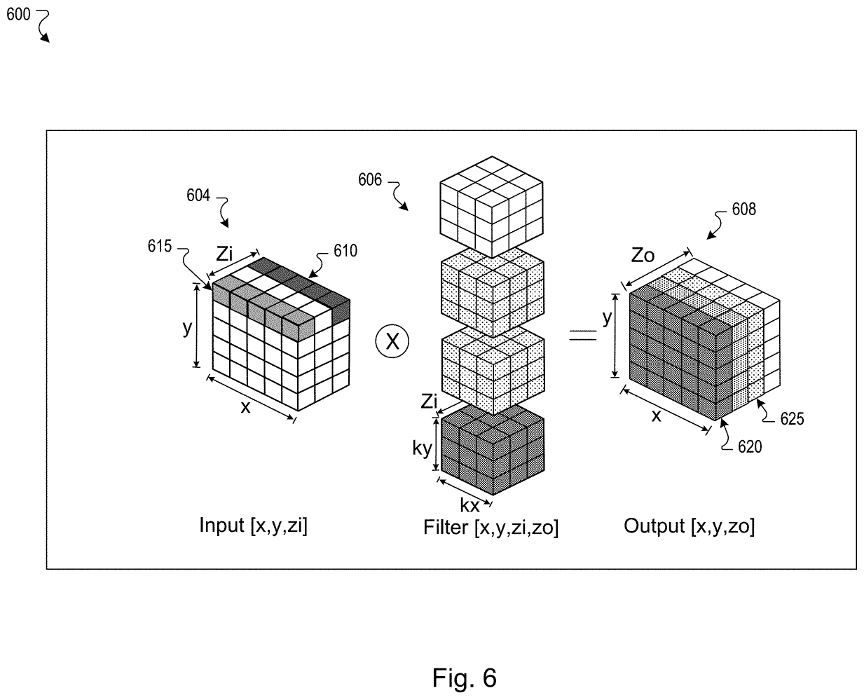

FIG. 6 illustrates examples of tensors or multi-dimensional matrices 600 that include an input tensor 604, variations of a weight tensor 606, and an output tensor 608. Tensors 600 are example machine-learning data structures that are processed or generated using a special-purpose processor, such as one that includes the circuit architecture of integrated circuit 100 (see FIG. 1). For example, the disclosed circuit architecture can be used in one or more ML hardware accelerators of system 100, which are configured to implement a neural network that receives and processes data of at least tensors 604 and 606.

Each of the tensors 600 include elements that correspond to data values for computations performed at a given layer of a neural network. The computations can include multiplication of an input/activation tensor 604 with a parameter/weight tensor 606 on one or more clock cycles to produce outputs such as activation/output values that can be provided as inputs to another neural network layer. These computations, including the multiplications, can be performed by one or more compute tiles 110, 114.

In some cases, the system 100 uses routing network 200 to use one or more vector units to support the computations performed by a compute tile 110. In the example of FIG. 6, each output in a set of outputs can correspond to a respective element of output tensor 608. In some examples, input tensor 604 is an activation tensor that is generated based on computations performed by a compute tile 110, a vector unit 118, or both. Multiplying an activation tensor 604 with a corresponding weight tensor 606 includes multiplying an activation from an element of tensor 604 with a weight from an element of tensor 606 to produce a partial sum(s).

In some implementations, the one or more sets of compute tiles and a corresponding vector unit 118 in the integrated circuit 100 are respective processor cores that operate on vectors. The vectors can include multiple discrete elements along a same (or different) dimension of some multi-dimensional tensor. Each of the multiple elements can be represented using X,Y coordinates (2D) or using X,Y,Z coordinates (3D) depending on the dimensionality of the tensor. The circuit architectures and hardware layouts described in this document can be optimized to compute multiple partial sums and perform inference or training operations with improved efficiency and latency relative to prior approaches. As noted above, the partial sums can correspond to products generated from multiplying a batch inputs with corresponding weight values.

For example, an input-weight multiplication may be written as a sum-of-product of each weight element multiplied with discrete inputs of an input volume, such as a row or slice of the input tensor 604. This row or slice can represent a given dimension, such as a first dimension 610 of the input tensor 604 or a second, different dimension 615 of the input tensor 604. The dimensions may be mapped to various compute tiles 110, 114 and vector processing units 118 across different hardware blocks of the integrated circuit 100 such that an example ML accelerator can routinely performs its computations in a manner that precludes load imbalances and achieves threshold processing utilizations at each compute tile and vector unit.

In some implementations, an example set of computations can be used to compute an output for a convolutional neural network layer. The computations for the CNN layer can involve performing a 2D spatial convolution between a 3D input tensor 604 and at least one 3D filter (weight tensor 606). For example, convolving one 3D filter 606 over the 3D input tensor 604 can produce a 2D spatial plane 620 or 625. The computations can involve computing sums of dot products for a particular dimension of the input volume. For example, the spatial plane 620 can include output values for sums of products computed from inputs along dimension 610, whereas the spatial plane 625 can include output values for sums of products computed from inputs along dimension 615. The computations to generate the sums of the products for the output values in each of spatial planes 620 and 625 are performed using the circuit architectures and techniques described in this document. For example, depending on a partitioning of the tensors, the computations may be performed at vector unit 118-0, vector unit 118-1, or both. The computations may also involve additional vector units 118 and super one-dimensional units 116.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. An integrated circuit for implementing a neural network comprising a plurality of neural network layers, the circuit comprising:
a plurality of compute tiles configured to process data used to generate an output of a neural network layer;
a first vector unit configured to perform operations on first data values provided along a first dimension of the integrated circuit from a first subset of the plurality of compute tiles;
a second vector unit configured to perform operations on second data values provided along the first dimension of the integrated circuit from a second subset of the plurality of compute tiles;
a set of data paths configured to couple a given vector unit and a particular subset of compute tiles such that data values are routable between the given vector unit and the particular subset of compute tiles; and
a set of vector data paths configured to couple the first vector unit and the second vector unit to support neural network computations that are performed using one or more of the plurality of compute tiles.

2. The integrated circuit of claim 1, wherein the plurality of compute tiles and the first and second vector units cooperate to generate respective outputs for each layer of the plurality of neural network layers based on data values that are routed using the set of data paths and the set of vector data paths.

3. The integrated circuit of claim 2, further comprising:
a first set of data paths configured to couple the first vector unit and the first subset of compute tiles such that the first data values are routable between the first vector unit and the first subset of compute tiles; and
a second set of data paths configured to couple the second vector unit and the second subset of compute tiles such that the second data values are routable between the second vector unit and the second subset of compute tiles.

4. The integrated circuit of claim 3, further comprising:
a first set of vector data paths configured to couple the first vector unit and the second vector unit along the first dimension of the integrated circuit to support the neural network computations that are performed using one or more of the plurality of compute tiles.

5. The circuit of claim 4, further comprising:
a second set of vector data paths configured to couple the first vector unit or the second vector unit to another vector unit along a second dimension of the integrated circuit to support the neural network computations that are performed using one or more of the plurality of compute tiles.

6. The integrated circuit of claim 5, wherein:
the integrated circuit is a neural network processor configured to perform deterministic operations based on a plurality of predetermined instructions that are executed using one or more sets of clock signals; and
the first and second set of data paths and the first and second set of vector data paths are a dynamically configurable routing network of the neural network processor that dynamically routes data processed by the neural network processor.

7. The integrated circuit of claim 3, wherein:
data paths in the first set of data paths are partial-sum buses configured to provide a first portion of partial sums from the first subset of compute tiles to the first vector unit when performing the neural network computations; and
data paths in the second set of data paths are partial-sum buses configured to provide a second portion of partial sums from the second subset of compute tiles to the second vector unit when performing the neural network computations.

8. The integrated circuit of claim 1, wherein the data comprise:
a first plurality of inputs that are processed at the neural network layer to generate a first plurality of activation values representing the output of the neural network layer; or
a second plurality of inputs that are processed at a second neural network layer to generate a second plurality of activation values representing an output of the second neural network layer.

9. The integrated circuit of claim 8, wherein:
the output of the neural network layer is provided as an input to the second neural network layer, such that the first plurality of activation values and the second plurality of inputs are the same.

10. The integrated circuit of claim 1, further comprising:
a functional memory unit configured to perform arithmetic operations that enable interpolation of data values obtained from a loadable table of values,
wherein the loadable table is accessible at the integrated circuit.

11. The integrated circuit of claim 1, wherein:
each of the plurality of compute tiles includes a respective multi-dimensional array of compute cells that are configured to compute one or more partial sums.

12. A method for generating an output of a neural network layer using a plurality of compute tiles of an integrated circuit that implements a neural network comprising a plurality of neural network layers, the method comprising:
computing, using the plurality of compute tiles, multiple data values from an input dataset;
processing, by a first vector unit of the integrated circuit, first data values provided along a first dimension of the integrated circuit from a first subset of the plurality of compute tiles;
processing, by a second vector unit of the integrated circuit, second data values provided along the first dimension of the integrated circuit from a second subset of the plurality of compute tiles;
using vector data paths that couple the first and second vector units to route different types of data values between the first vector unit and second vector unit when the first or second data values are being processed; and
generating the output of the neural network layer based on the processing of the first or second data values and the different types of data values that are routed between the first and second vector units via the set of vector data paths.

13. The method of claim 12, wherein processing the first data values comprises:
processing the first data values in response to receiving the first data values along the first dimension from the first subset of compute tiles via a first set of data paths that are configured to couple the first subset of compute tiles and the first vector unit, such that the first data values are routable between the first subset of compute tiles and the first vector unit.

14. The method of claim 13, wherein processing the second data values comprises:
processing the second data values in response to receiving the second data values along the first dimension from the first subset of compute tiles via a second set of data paths that are configured to couple the second subset of compute tiles and the second vector unit, such that the second data values are routable between the second subset of compute tiles and the second vector unit.

15. The method of claim 14, wherein data paths in the first set of data paths are partial-sum buses and the method comprises:
providing, via the first set of data paths, a first portion of partial sums from the first subset of compute tiles to the first vector unit when performing neural network computations at the integrated circuit.

16. The method of claim 15, wherein data paths in the second set of data paths are partial-sum buses and the method comprises:
providing, via the second set of data paths, a second portion of partial sums from the second subset of compute tiles to the second vector unit when performing the neural network computations at the integrated circuit.

17. The method of claim 15, wherein the plurality of compute tiles and the first and second vector units cooperate to generate respective outputs for each layer of the plurality of neural network layers based on data values that are routed using the first and second set of data paths and the vector data paths.

18. The method of claim 17, wherein:
the integrated circuit is a neural network processor configured to perform deterministic operations based on a plurality of predetermined instructions that are executed using one or more sets of clock signals; and
the method further comprises: dynamically configuring a routing network of the neural network processor to dynamically route data processed by the neural network processor when performing the neural network computations.

19. The method of claim 18, wherein the routing network comprises the first and second set of data paths and the vector data paths; and the vector data paths comprise:
a first set of vector data paths configured to couple the first vector unit and the second vector unit along the first dimension of the integrated circuit; and
a second set of vector data paths configured to couple the first vector unit or the second vector unit to another vector unit along a second dimension of the integrated circuit.

20. A system comprising:
a processing device;
an integrated circuit that implements a neural network comprising a plurality of neural network layers; and
a non-transitory machine-readable storage device storing instructions for generating an output of a neural network layer using a plurality of compute tiles of the integrated circuit, the instructions being executable by the processing device to cause performance of operations comprising:
computing, using the plurality of compute tiles, multiple data values from an input dataset;
processing, by a first vector unit of the integrated circuit, first data values provided along a first dimension of the integrated circuit from a first subset of the plurality of compute tiles;
processing, by a second vector unit of the integrated circuit, second data values provided along the first dimension of the integrated circuit from a second subset of the plurality of compute tiles;
using vector data paths that couple the first and second vector units to route different types of data values between the first vector unit and second vector unit when the first or second data values are being processed; and
generating the output of the neural network layer based on the processing of the first or second data values and the different types of data values that are routed between the first and second vector units via the set of vector data paths.
